(19) United States
(12) Patent Application Publication
(10) Pub. No.: US 2011/0188259 A1
(43) Pub. Date: Aug. 4, 2011

(54) Motor vehicle lighting accessory for optimizing emitted light from headlamp systems

(76) Inventor: Sherman Bungay Simbulan, San Diego, CA (US)

(21) Appl. No.: 12/699,945

(22) Filed: Feb. 4, 2010

(51) Int. Cl. F21S 8/10

(52) U.S. Cl. 362/544

(57) ABSTRACT

An external lighting accessory designed to optimize the distribution of light emitted from motor vehicle headlamp systems. The operator of the motor vehicle or installer simply has to install one lighting accessory per headlamp. The light emitted from the motor vehicle headlamps, in combination with the lighting accessory, are instantly optimized for driving. Said lighting accessory is constructed of a translucent flexible material, can either be clear or tinted, is self adhesive, and is reusable. Various embodiments of the lighting accessory exist to allow the end user the ability to customize the focus and tint of virtually any motor vehicle headlamp.

### FIELD OF THE INVENTION

This invention relates to motor vehicle forward facing headlamp systems and more specifically relates to improving the focus and color of light emitted from motor vehicle headlamps to aid in clarifying the vehicle operator's field of view in various driving conditions.

### BACKGROUND OF THE INVENTION

The purpose of the vehicle headlamp system is to illuminate the field of view of the operator of the motor vehicle while operating the vehicle in low light or completely dark driving conditions. The light emitted from these headlamp systems are designed to disperse light in such as way as to maximize the effectiveness of the light output to improve the clarity of the operator's field of view.

Different driving conditions warrant different optimized lighting characteristics. Original equipment manufacture, OEM, headlamps are only equipped to adjust the aim of the emitted light. OEM headlamps usually require a special tool to adjust the aim and are very inconvenient and complicated for the end user/operator to perform. The ability to customize the aim, focus, and tint of the emitted light, without the use of tools, would benefit motor vehicle operators greatly and aid the operator in achieving a safer driving experience.

### SUMMARY OF THE INVENTION

It is the purpose of this invention to provide motor vehicle operators the ability to customize their forward lighting system to suit their current driving condition, without the use of tools.

Motor vehicle headlamps are designed to emit light in such a fashion that objects far, near, and to the sides are illuminated as much as possible. The inventor observed that different vehicles designed for different purposes, have headlamps designed to direct light to areas complementary to the intended purpose of the vehicle. Sports cars, which are generally lower to the ground, have headlamps which project light, further down the road as compared to a sport utility vehicle; which rides much higher off the ground and has headlamps which project light more laterally with less of an emphasis on projecting light further down the road. Common sedans and mini-vans, for all intents and purposes, have headlamps which project light as far down the road as possible while maintaining an acceptable lateral projection.

It is the inventors' observation that some motor vehicle operators do not adhere to the suggested use of their chosen vehicle. Sports cars, sedans, and mini-vans, for the most part, are being used for their designed purpose, but sport utility vehicle, SUV, and small truck operators are now using their vehicles in similar manners as sedans, mini-vans, and the like. The invention will allow any motor vehicle operator to customize the throw and tint of the light emitted from their respective vehicles' headlamp system.

In the instance where the motor vehicle is being operated in an area where the roads are long and relatively straight, such as modern urban highways, where the weather is clear and/or the vehicle speed is high, a whiter light with a bluish tint, focused further down the road may be more ideal. In the instance where the vehicle is being driven in tight, winding, or narrow roads, a whiter light focused closer and to the outside may be more effective.

In adverse driving conditions such as fog, rain, or snow, the light emitted from the vehicle headlamp system will reflect off of the airborne particulates within the operators' field of view, decreasing the clarity and depth of the vehicle operators' field of view, whether those particulates consist of fog, rain, snow, or a combination thereof. In this situation, amber colored light focused lower, to the outside, and further down the road will be more effective than the standard focused motor vehicle headlamp.

One embodiment of the invention is comprised of a self adhesive translucent material of which the exterior surface of the invention is covered with numerous concentric ridges radiating from center. The ridges are shaped such that the light emitted from the headlamps, when passing through the invention, is focused further down the road. This embodiment is ideal for use on vehicles whose headlamps only use one bulb for both high and low beam modes, but can also be applied to headlamps which have a dedicated bulb for each output mode.

Another embodiment of the invention is comprised of a self adhesive translucent material of which the exterior surface of the invention is covered with numerous concentric ridges radiating from center. The ridges are shaped such that the light emitted from the headlamps, when passing through the invention, is focused closer in as well as projecting light laterally. This embodiment is ideal for use on vehicles whose headlamps only use one bulb for both high and low beam modes, but can also be applied to headlamps which have a dedicated bulb for each output mode.

Another embodiment of the invention is comprised of a self adhesive translucent material of which the exterior surface is covered with numerous concentric ridges on one portion and linear ridges on another portion. The concentric ridges are shaped such that light emitted from the headlamps, when passing through the invention, is focused further down the road; while the linear ridges are shaped such that light emitted from the headlamps, when passed through the invention, is directed to the outside. This embodiment is ideal for use on vehicles whose headlamps use one bulb for both high and low beam modes, but is also compatible with headlamps using a dedicated bulb for each mode.

All embodiments of the invention are reusable. The adhesive used is non-permanent and will retain its adhesive properties over multiple uses so long as the adhesive is not contaminated and is returned to its container when not in use. All embodiments can also be tinted a variety of different colors during manufacturing, resulting in a myriad of different tint and focusing combinations.

Other objects, features, and advantages will be easily apparent from the following accompaniment of drawings and description of the preferred embodiment, in conjunction with the previously stated claims.

### BRIEF DESCRIPTION OF DRAWINGS

FIG. 1 is an illustration of the front end of a generic motor vehicle with two forward facing headlamps, embodying the present invention installed on the observer's left headlamp.

FIG. 2 is an illustration of a generic single motor vehicle headlamp with an embodiment of the invention not installed, but where the invention is ready to install.

FIG. 3 is a front view of the first and second embodiments of the invention.

FIG. 4 is a longitudinal cross section view of the first embodiment showing the ridges on the exterior surface of the invention as well as the layer of adhesive on the interior surface.

FIG. 5 is a longitudinal cross section view of the second embodiment showing the ridges on the exterior surface of the invention as well as the layer of adhesive on the interior surface.

FIG. 6 is a front view of the third embodiment of the invention

FIG. 7 is a longitudinal cross section view of the third embodiment showing the ridges on the exterior surface of the invention as well as the layer of adhesive on the interior surface.

FIG. 8 is a longitudinal cross section view of the fourth embodiment showing the ridges on the exterior surface of the invention as well as the layer of adhesive on the interior surface.

FIG. 9 is a front view of the fifth embodiment of the invention

FIG. 10 is longitudinal cross section view of the fifth embodiment showing the ridges on the exterior surface of invention as well as the layer of adhesive on the interior surface

### DESCRIPTION OF THE PREFERRED EMBODIMENT

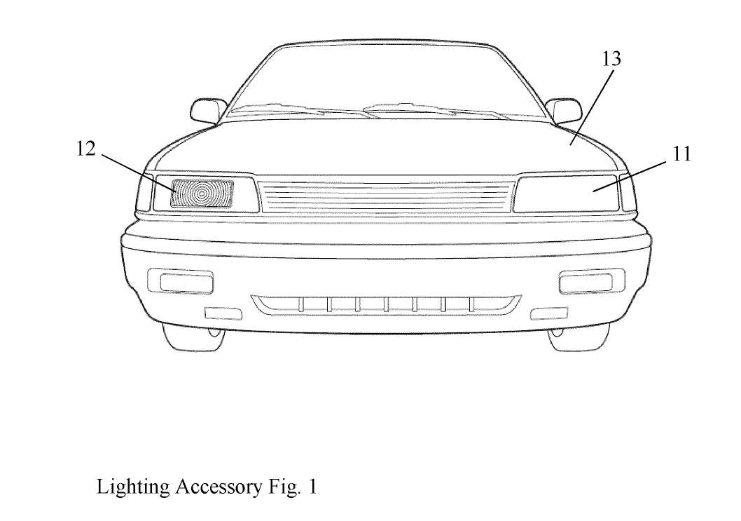

FIG. 1 shows a generic motor vehicle 13 that has two forward facing headlamps 11. The invention 12 is shown attached to the headlamp on the observer's left. Final placement of the invention on the surface of the headlamp is varied due to the different sizes and shapes of modern vehicle headlamps.

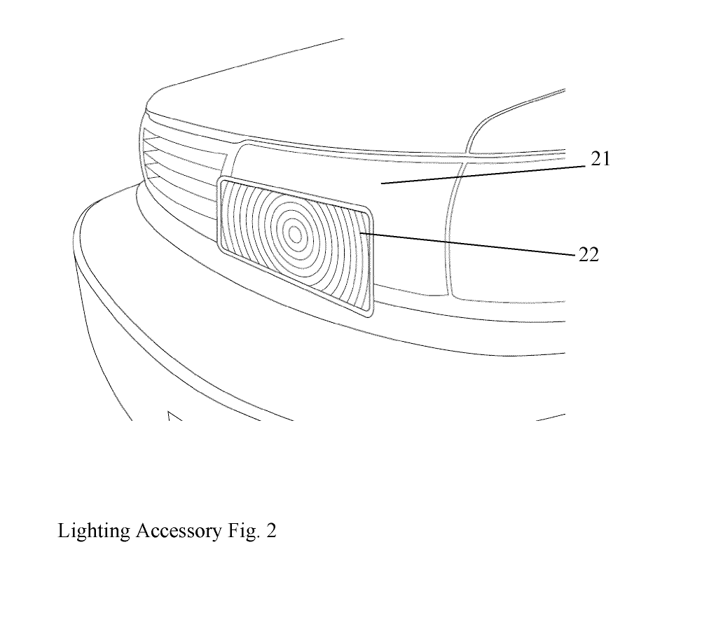

FIG. 2 shows the action of positioning the invention 22 prior to application on the motor vehicle headlamp 21. Prior to installation, the operator or installer must position the invention such that the light being emitted from the headlamp has been directed to the desired field of view.

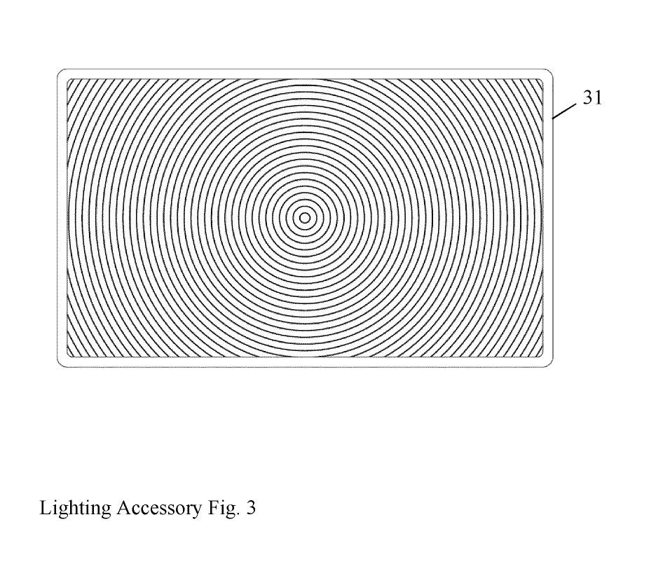

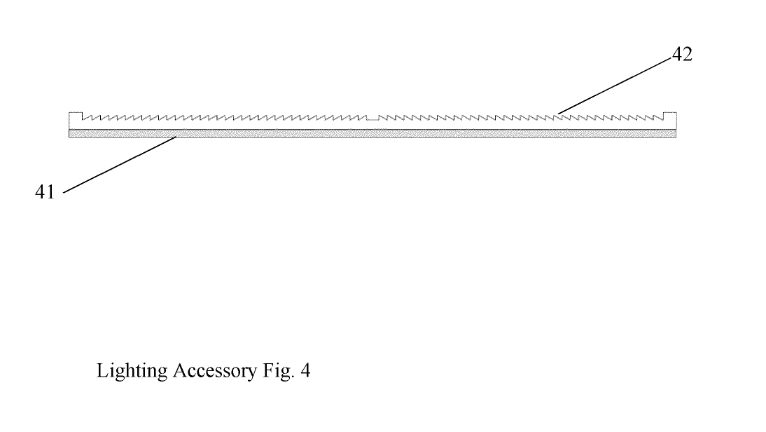

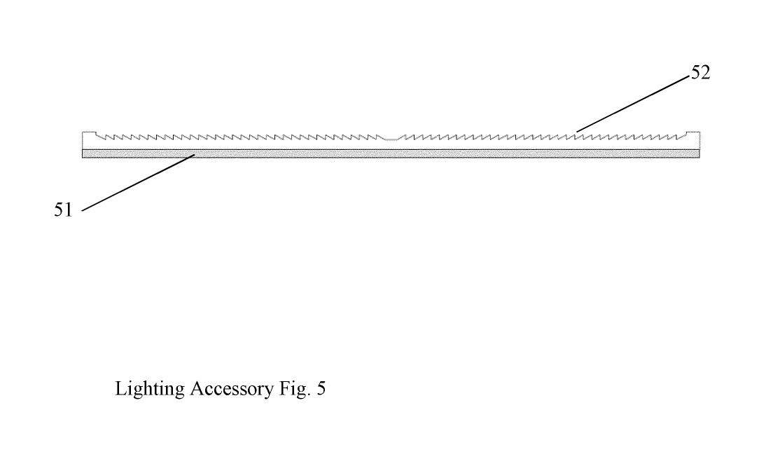

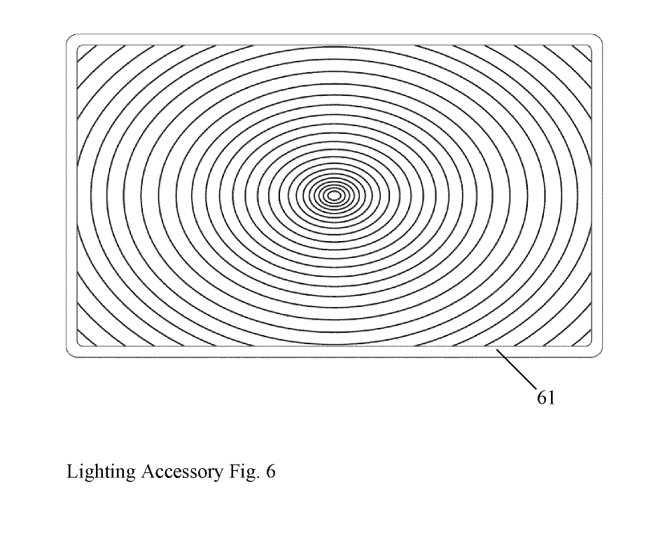

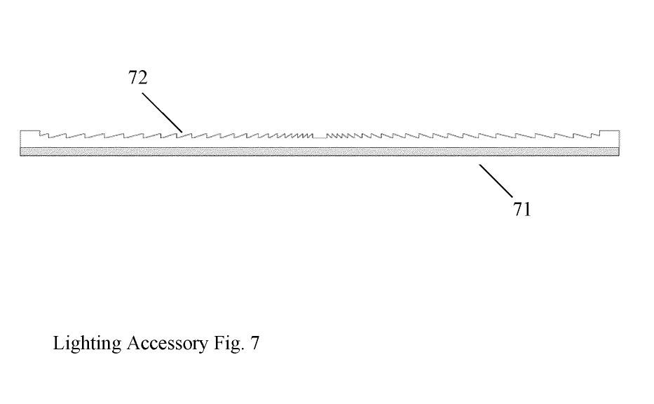

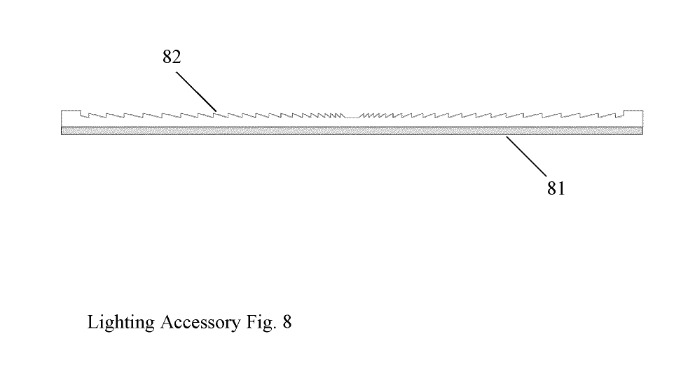

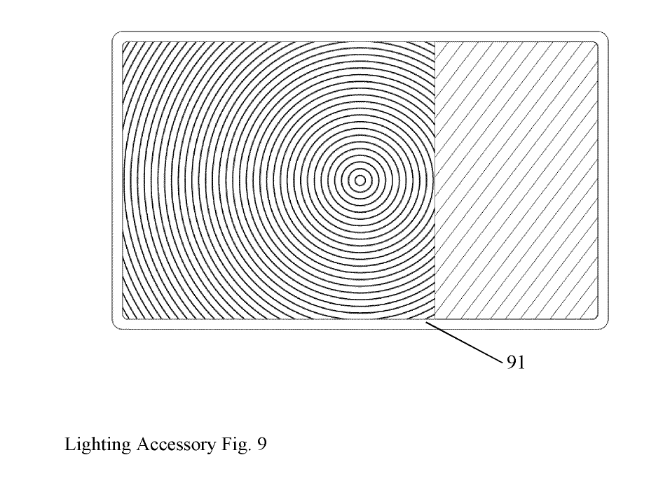

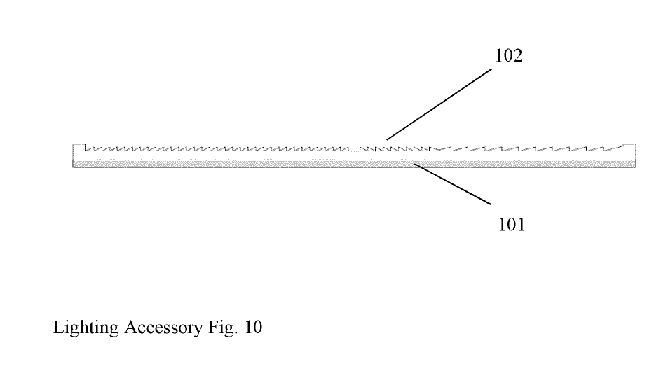

FIGS. 3, 6, and 9 show various embodiments of the invention shown from a front facing view as if the invention was held with the exterior, non adhesive lined, surface facing the user. FIGS. 4 and 5 show longitudinal cross sections of embodiments represented by FIG. 3. FIGS. 7 and 8 show longitudinal cross sections of embodiments represented by FIG. 6. FIG. 10 is a longitudinal cross section of the embodiment represented by FIG. 9

In each embodiment, the ridges, by design, redirect light that passes through the invention from the headlamp. The angle, direction, and shape of the ridges dictate how the light is redirected or focused. The translucence of the material allows for little or no loss of lumens, otherwise known as the measure of the power of light as perceived by the human eye.

There are many processes to which the invention can be manufactured. The most efficient would be injection molding in which the preferred material would be a clear, high transmittance thermoplastic which could be optionally tinted during manufacture.

While a presently preferred embodiment of the invention has been presented; alterations and other embodiments are possible without departing from the principles and scope of the stated claims.

What is claimed is:

1. A motor vehicle headlamp system being the sum total of forward facing headlamps; more commonly but not restricted to, motor vehicle headlamp systems consisting of two forward facing headlamps, one on each front corner of the vehicle; or in the case of motor vehicles with only one forward facing headlamp, one lamp centered on the vehicle; and each headlamp having the capability to emit light in two modes, low beam or high beam; in instances where the headlamp only uses a single bulb for the high and low beam modes, the low beam is automatically deactivated when the high beam is activated; furthermore, in instances where the headlamp uses two separate bulbs, one for low beam and one for high beam, dependent upon design of the manufacturer of the vehicle headlamp system, the low beam may or may not remain activated when the high beam mode is chosen.

2. A motor vehicle headlamp system as set forth in claim 1 wherein the exterior lighting accessory is comprised of a self adhesive, flexible, and optionally tinted translucent material.

3. A motor vehicle headlamp system as set forth in claim 1 and an exterior lighting accessory as set forth in claim 2 wherein the interior surface of the lighting accessory is coated with adhesive and is the surface which is attached to the exterior of the vehicle headlamp.

4. An exterior lighting accessory as set forth in claim 2 wherein the exterior surface of the lighting accessory is covered with either radial and/or linear ridges or a combination thereof.

5. The interior surface of the lighting accessory as set forth in claim 3 and the exterior surface of the lighting accessory as set forth in claim 4 wherein a longitudinal cross section of the lighting accessory reveals the interior and exterior angles of the ridges on the exterior surface, in relation to the plane formed by the interior surface.

6. A motor vehicle headlamp system as set forth in claim 1, the interior surface of the lighting accessory as set forth in claim 3, and the exterior surface of the lighting accessory as set forth in claim 4 and claim 5 wherein the interior and exterior angles of the ridges on the exterior surface, as visible on a longitudinal cross section of the lighting accessory, are dependent on the design of the motor vehicle headlamp system and desired focus of the motor vehicle operator.

7. A motor vehicle headlamp as set forth in claim 1 and an exterior lighting accessory as set forth in claim 2 wherein the exterior lighting accessory is fitted to the motor vehicle head lamp in such a way that the exterior surface of the headlamp is not completely covered by the lighting accessory of which placement of the lighting accessory on the motor vehicle head lamp is varied by the installer to direct emitted light to the desired area within the field of view of the motor vehicle operator.

8. A motor vehicle headlamp as set forth in claim 1 and an exterior lighting accessory as set forth in claim 2 wherein optional tinting of the translucent material will create a greater color contrast between the light emitted from the motor vehicle headlamps and illuminated objects within the field of view of the motor vehicle operator; where tinting of the lighting accessory will be integrated into the manufacturing process.
